(19) United States
(12) Patent Application Publication
(10) Pub. No.: US 2011/0293189 A1
(43) Pub. Date: Dec. 1, 2011

(54) Facial Analysis Techniques

(75) Inventors: Jian Sun, Beijing (CN); Zhimin Cao, Hong Kong (CN); Qi Yin, Beijing (CN)

(73) Assignee: Microsoft Corporation, Redmond, WA (US)

(21) Appl. No.: 12/790,173

(22) Filed: May 28, 2010

(51) Int. Cl. G06K 9/46

(52) U.S. Cl. 382/195

(57) ABSTRACT

Described herein are techniques for obtaining compact face descriptors and using pose-specific comparisons to deal with different pose combinations for image comparison.

### BACKGROUND

Recently, face recognition has attracted much research effort due to increasing demands of real-world applications, such as face tagging on the desktop or the Internet.

There are two main kinds of face recognition tasks: face identification (who is who in a probe face set, given a gallery face set) and face verification (same or not, given two faces). One of the challenges for face recognition is finding efficient and discriminative facial appearance descriptors that are resistant to large variations in illumination, pose, face expression, aging, face misalignment and other factors.

Current descriptor-based approaches uses handcrafted encoding methods to encode a relative intensity magnitude between each pixel and its neighboring pixels to identify a face. User desire to improve upon such handcrafted encoding methods to obtain an effective and compact face descriptor for face recognition across different datasets.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

The Detailed Description describes a learning-based encoding method for encoding micro-structures of a face. The Detailed Description also describes a method for applying dimension reduction techniques, such as principal component analysis (PCA), to obtain a compact face descriptor, and a simple normalization mechanism afterwards. To handle large pose variations in real-life scenarios, the Detailed Description further describes a pose-adaptive matching method for using pose-specific classifiers to deal with different pose combinations (e.g., frontal vs. frontal, frontal vs. left) of matching face pairs.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary method of descriptor-based facial image analysis.

FIG. 2 illustrates four sampling patterns.

FIG. 3 illustrates an exemplary method of creating an encoder for use in descriptor-based facial recognition.

FIG. 4 illustrates an exemplary method of descriptor-based facial analysis that is adaptive to pose variations

FIG. 5 illustrates comparison of two images to determine similarity, using results of the techniques described above with reference to FIG. 4.

FIG. 6 illustrates an exemplary computing system.

### DETAILED DESCRIPTION

### Descriptor-Based Face Analysis and Representation

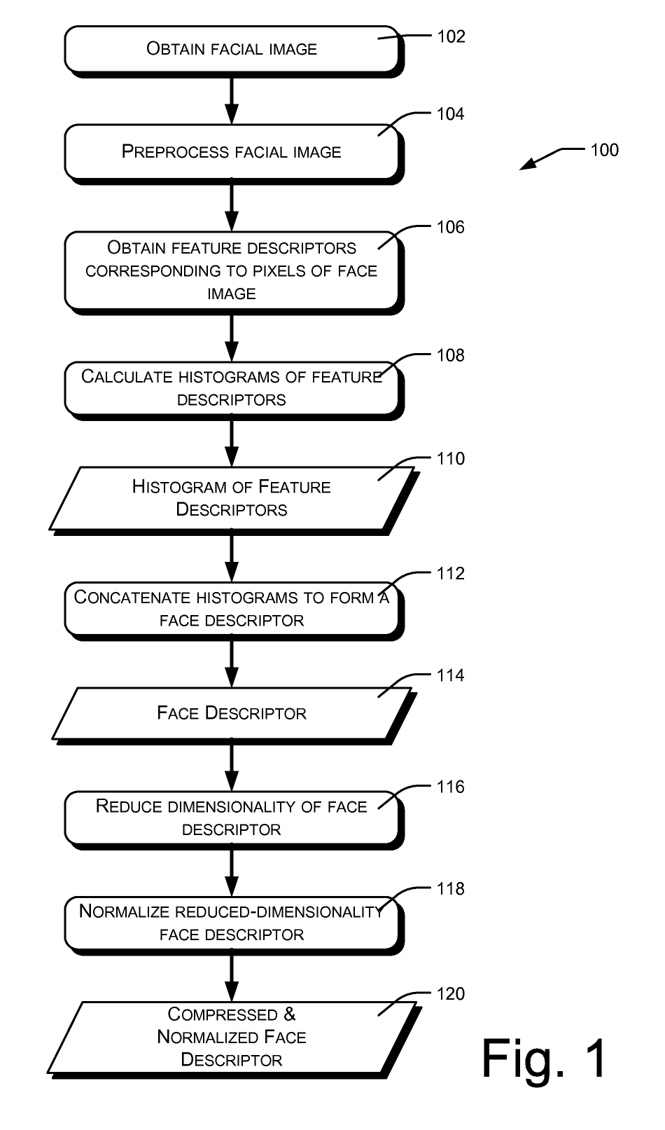

FIG. 1 illustrates an exemplary method 100 of descriptor-based facial image analysis, using histograms of Local Binary Patterns (LBPs) to describe microstructures of the face. LBP encodes the relative intensity magnitude between each pixel and its neighboring pixels. It is invariant to monotonic photometric change and can be efficiently extracted and/or compared.

In the method of FIG. 1, an action 102 comprises obtaining a facial image. The source of the facial image is unlimited. It can be captured by a local camera or downloaded from a remote online database. In the example of FIG. 1, the facial image is an image of an entire face. An action 104 comprises preprocessing the facial image to reduce or remove low-frequency and high-frequency illumination variations. This can be accomplished with difference of Gaussian (DoG) techniques, using σ₁=2.0 and σ₂=4.0 in the exemplary embodiment. Other preprocessing techniques can also be used.

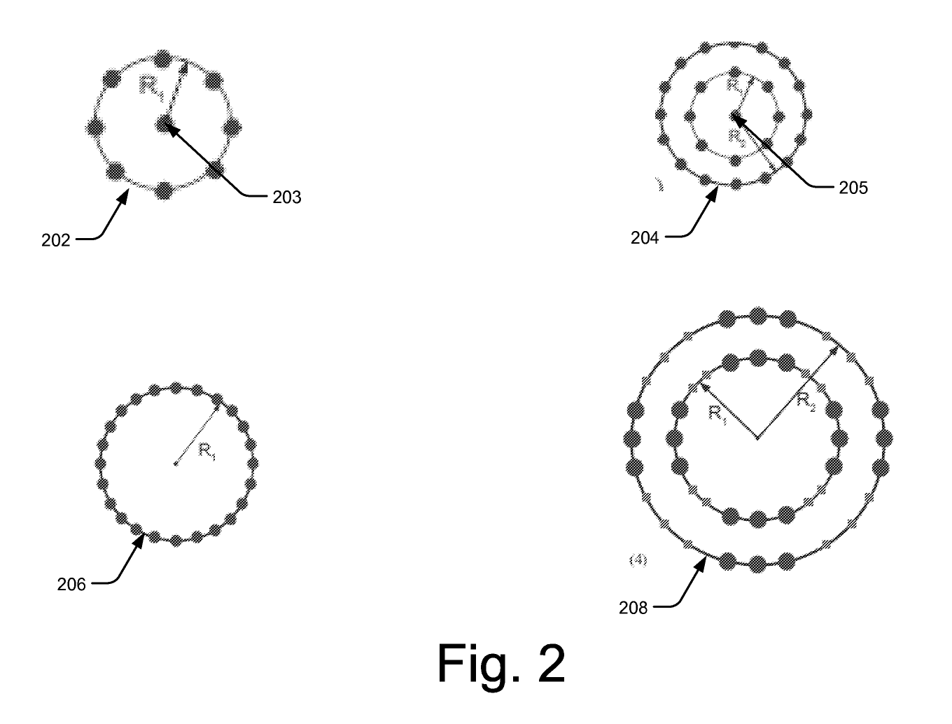

An action 106 comprises obtaining feature vectors or descriptors corresponding respectively to pixels of the facial image. In the described embodiment, each pixel and a pattern of its neighboring pixels are sampled to form a low-level feature vector corresponding to each pixel of the image. Each low-level feature vector is then normalized to unit length. The normalization, combined with the previously mentioned DoG preprocessing, makes the feature vectors less variant to local photometric affine change. Specific examples of how to perform the sampling will be described below, with reference to FIG. 2.

Action 106 includes encoding or quantizing the normalized feature vectors into discrete codes to form feature descriptors. The encoding can be accomplished using a predefined encoding method, scheme, or mapping. In some cases, the encoding method may be manually created or customized by a designer in an attempt to meet specialized objectives. In other cases, as will be described in more detail below, the encoding method can be created programmatically. In the example described below, the encoding method is learned from a plurality of training or sample images, and optimized statistically in response to analysis of those training image.

The result of the actions described above is a 2D matrix of encoded feature descriptors. Each feature descriptor is a multi-bit or multi-number vector. Within the 2D matrix, the feature descriptors have a range that is determined by the quantization or code number of the encoding method. In the described embodiment, the feature descriptors are encoded into 256 different discrete codes.

An action 108 comprises calculating histograms of the feature descriptors. Each histogram indicates the number of occurrences of each feature descriptor within a corresponding patch of the facial image. The patches are obtained by dividing the overall image in accordance with technologies such as those described in Ahonen et al's Face Recognition with Local Binary Patterns (LBP), Lecture Notes in Computer Science, pages 469-481, 2004. As an example, the image may be divided into patches having pixels dimensions of 5×7, in relation to an overall facial image having pixel dimensions of 84×96. A histogram is computed for each patch and the resulting computed histograms 110 of the feature descriptors are processed further in subsequent actions.

An action 112 comprises concatenating histograms 110 of the patches, resulting in a single face descriptor 114 corresponding to the facial image. This face descriptor can be compared to similarly calculated face descriptors of different images to evaluate similarity between images and to determine whether two different images are of the same person.

In some embodiments, further actions can be performed to enhance the face descriptors before they are used in comparisons. An action 116 may be performed, comprising reducing the dimensionality of face descriptor 114 using one or more statistical vector quantization techniques. This is helpful because if the concatenated histogram is directly used as face descriptor, it may be too large (e.g., 256 codes×35 patch=8,960 dimensions). A large or heavy feature descriptor not only limits the number of faces that can be loaded into memory, but also slows down recognition speed. To reduce the feature descriptor size, one or more statistical vector quantization techniques can be used. For example, principal component analysis (PCA) can be used to compress the concatenated histogram. The one or more statistical vector quantization techniques can also comprise linear PCA or feature extraction. In one example, the statistical dimensions reduction techniques are configured to reduce the dimensionality of face descriptor 114 to a dimension of 400.

An action 118 can also be performed, comprising normalizing the reduced-dimensionality face descriptor to obtain a compressed and normalized face descriptor 120. In this embodiment, the normalization comprises L₁ normalization and L₂ normalization in PCA where L₁ represents city-block metrics and L₂ represents Euclidean distance. Surprisingly, the combination of PCA compression and normalization improves the performance of recognition and identifications systems, indicating that the angle difference between features is important for recognition in the compressed space.

### Feature Sampling

Action 106 above includes obtaining feature vectors or descriptors corresponding respectively to pixels of the facial image by sampling neighboring pixels. This can be accomplished as illustrated in FIG. 2, in which r*8 pixels are sampled at even intervals on one or more rings of radius r surrounding the center pixel 203. FIG. 2 illustrates four sampling patterns. Parameters (e.g., ring number, ring radius, sampling number for each ring) are varied for each pattern. In a pattern 202, a single ring is used of radius 1, referred to as R₁. This pattern includes the 8 pixels surrounding the center pixel 203, and also includes center pixel (pixels are represented in FIG. 2 as solid dots). In a different pattern 204, two rings are sampled, having radii 1 and 2. Ring R₁ includes all 8 of the surrounding pixels. R₂ includes the 16 surrounding pixels. Pattern 204 also includes the center pixel 205. In another pattern 206, a single ring R₁, with radius 3, is used without the center pixel, and all 24 pixels at a distance of 3 pixels from the center pixel are sampled. Another sampling pattern 208 includes two pixel rings: R₁, with radius 4, and R₂, with radius 7. 32 pixels are sampled at ring R₁, and 56 pixels are sampled at ring R₂ (for purposes or illustration, some groups of pixels are represented as x's). The above numbers of pixels at rings are mere examples. There can be more or less pixels on each ring, and various different patterns can be devised.

Pattern 204 can be used as a default sampling method. In some embodiments, some or all of patterns 202, 204, 206, 208, or different sampling patterns, can be combined to achieve better performance than using any single sampling pattern. Combining them in some cases will exploit complementary information. In one embodiment, the different patterns are used to obtain different facial similarity scores and then these scores are combined by training a linear support vector machine (SVM).

Machine-Learned Encoding from Sample Images

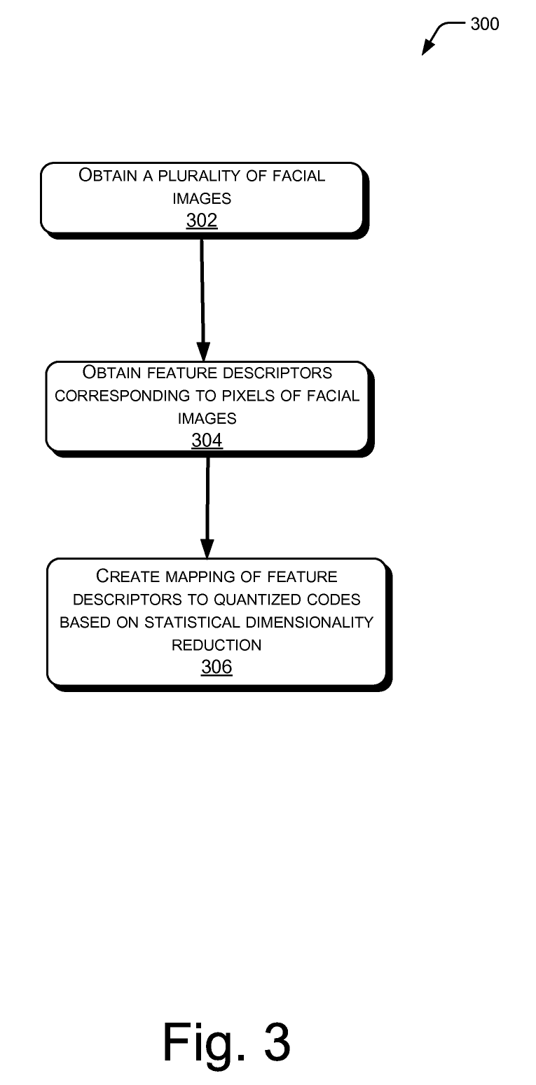

FIG. 3 illustrates an exemplary method 300 of creating an encoder for use in descriptor-based facial recognition. As mentioned above, action 106 of obtaining feature descriptors will in many situations involve quantizing the feature descriptors using some type of encoding method. Various different types of encoding methods can be used, to optimize discrimination and robustness. Generally, such encoding methods are created manually, based on intuition or direct observations of a designer. This can be a difficult process. Often, such manually designed encoding methods are unbalanced, meaning that the resulting code histograms will be less informative and less compact, degrading the discriminative ability of the feature and face descriptors.

However, certain embodiments described herein may use an encoding method that has been learned by machine, based on an automated analysis of a training set of facial images. Specifically, certain embodiments may use an encoder specially trained—in an unsupervised manner—for the face, from a set of training facial images. The resulting quantization codes are more uniformly distributed and the resulting histograms can achieve a better balance between discriminative power and robustness.

In exemplary method 300, an action 302 comprises obtaining a plurality of training or sample facial images. Facial image training sets can be obtained from different sources. In the embodiment described herein, method 300 is based on a set of sample images referred to as the Labeled Face in Wild (LFW) benchmark. Other training sets can also be compiled and/or created, based on originally captured images or images copied from different sources.

An action 304 comprises, for each of the plurality of sample facial images, obtaining feature vectors corresponding to pixels of the facial image. Feature vectors can be calculated in the manner described above with reference to action 104 of FIG. 1, such as by sampling neighboring pixels for each image pixel to create LBPs.

An action 306 comprises creating a mapping of the feature vectors to a limited number of quantized codes. In the described embodiment, this mapping is created or obtained based on statistical vector quantization, such K-means clustering, linear PCA tree, or random-projection tree.

Random-projection tree and PCA tree recursively split the data based on uniform criterion, which means each leaf of the tree is hit by the same number of vectors. In other words, all the quantized codes have a similar emergence frequency in the resulting descriptor space.

In testing, 1,000 images were selected from the public-domain LFW training set to learn an optimized encoding method or mapping. K-means clustering, linear PCA tree, random-projection tree were evaluated. In subsequent recognition tests using the resulting encodings on the test images, it was found that random-projection tree slightly out-performed the other two methods of quantization. Performance increased as the number of allowed quantization codes was increased. The described learning method began to outperform other existing methods as the code number was increased to 32 or higher. In the described embodiment, quantization is performed to result in a code number of 256: the resulting feature vectors have a range or dimension of 256.

### Component Descriptors

In the example above, 2D holistic alignment and matching were used for comparison. In other words, images were divided into patches irrespective of the locations of facial features in the images and irrespective of the different poses that might have been presented in the different images. However, certain techniques, to be described below, can be used to handle pose variation and further boost recognition accuracy. Compared with the 2D holistic alignment, this component level alignment can present advantages in some large pose-variant cases. The component-level approach can more accurately align each component without balancing across the whole face, and the negative effect of landmark error is also reduced.

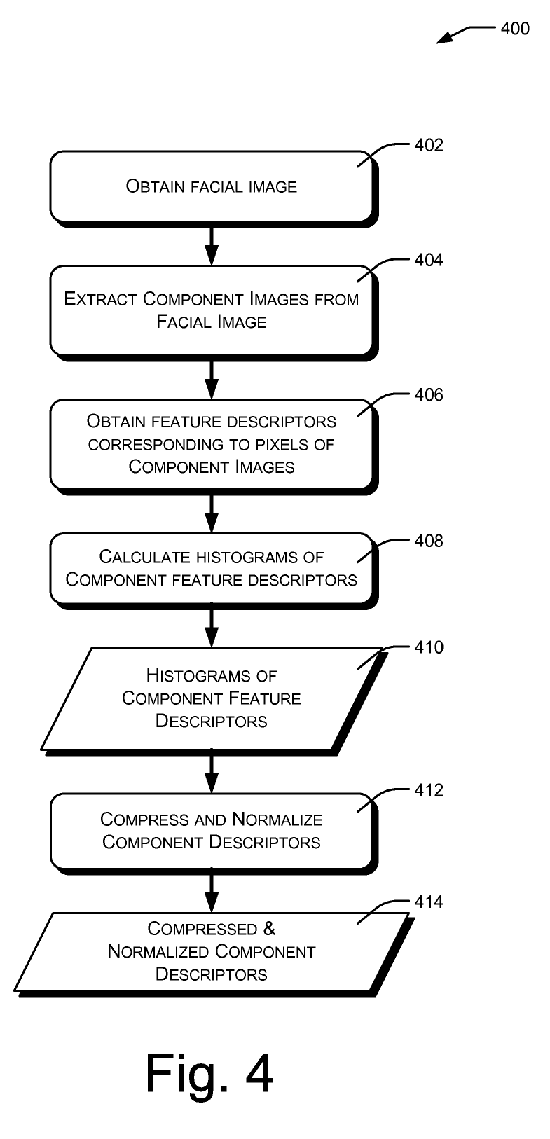

FIG. 4 illustrates an exemplary method 400 of descriptor-based facial analysis that is adaptive to pose variations. Instead of dividing a facial image into arbitrary patches as described above with reference to action 106 for purposes of creating feature descriptors 108, component images are identified within the facial image, and component descriptors are formed from the feature descriptors of the component images.

In this method 400, an action 402 comprises obtaining a facial image. An action 404 comprises extracting component images from the facial image. Each component image corresponds to a facial component, such as the nose, mouth, eyes, etc. In the described embodiment, action 404 is performed by identifying facial landmarks and deriving component images based on the landmarks. In this example, a standard fiducial point detector is used to extract face landmarks, which include left and right eyes, nose tip, nose pedal, and two mouth corners. From these landmarks, the following component images are derived: forehead, left eyebrow, right eyebrow, left eye, right eye, nose, left cheek, right cheek, and mouth. Specifically, to derive the position of a particular component image, two landmarks are selected from the five detected landmarks as follows:

TABLE 1
Landmark selection for component alignment

| Component | Selected landmarks |
|---|---|
| Forehead | left eye + right eye |
| Left eyebrow | left eye + right eye |
| Right eyebrow | left eye + right eye |
| Left eye | left eye + right eye |
| Right eye | left eye + right eye |
| Nose | nose tip + nose pedal |
| | (where the pedal of nose |
| | tip on eye line) |
| Left cheek | left eye + nose tip |
| Right cheek | right eye + nose tip |
| Mouth | two mouth corners |

Based on the selected landmarks, component coordinates are calculated using predefined dimensional relationships between the components and the landmarks. For example, the left cheek might be assumed to lie a certain distance to the left of the nose tip and a certain distance below the left eye.

For use in conjunction with the LFW test images, component images can be extracted with the following pixel sizes, and can be further divided into the indicated number of patches.

TABLE 2
Component Image Sizes and Patch Selection

| Component | Image Size | Patches |
|---|---|---|
| Forehead | 76 × 24 | 7 × 2 |
| Left eyebrow | 46 × 34 | 4 × 3 |
| Right eyebrow | 46 × 34 | 4 × 3 |
| Left eye | 36 × 24 | 3 × 2 |
| Right eye | 36 × 24 | 3 × 2 |
| Nose | 24 × 76 | 2 × 7 |
| Left cheek | 34 × 46 | 3 × 4 |
| Right cheek | 34 × 46 | 3 × 4 |
| Mouth | 76 × 24 | 7 × 2 |

An action 406 comprises obtaining feature descriptors corresponding respectively to pixels of the component images. The feature descriptors can be calculating using the sampling techniques described above with reference to action 108 of FIG. 1, and using the techniques described with reference to FIG. 2, such as by sampling neighboring pixels using different patterns.

An action 408 comprises calculating component descriptors corresponding respectively to the component images. This comprises first creating a histogram for each patch of each component image, and then concatenating the histograms within each component image. This results in a component descriptor 410 corresponding to each component image. Each component descriptor 410 is a concatenation of the histograms of the feature descriptors of the patches within each component image.

Method 400 can further comprise an action 412 of reducing the dimensionality of the component descriptors using statistical vector quantization techniques and normalizing the reduced-dimensionality component descriptors—as already described above with reference to actions 116 and 118 of FIG. 1. This results in compressed and normalized component descriptors 414, corresponding respectively to the different component images of the facial image.

Thus, this method can be very similar to that described above with reference to FIG. 1, except that instead of forming histograms of arbitrarily defined patches and concatenating them to form a single face descriptor, the histograms are formed based on the feature descriptors of the identified facial components. Instead of a single face descriptor, the process of FIG. 4 results in a plurality of component descriptors 414 for a single facial image.

### Pose-Adaptive Face Comparison

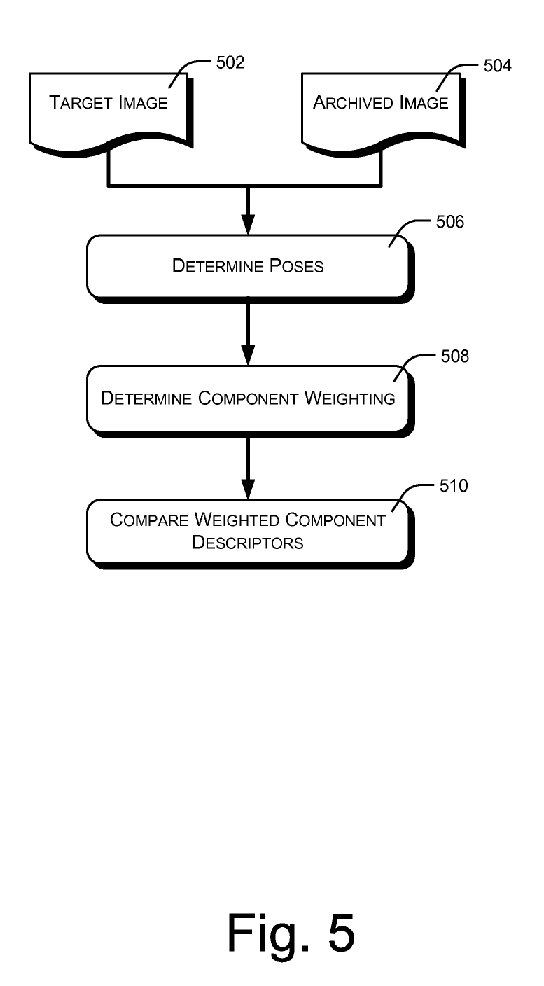

FIG. 5 illustrates comparison of two images to determine similarity, using results of the techniques described above with reference to FIG. 4. Facial identification and recognition is largely a process of comparing a target image to series of archived images. The example of FIG. 5 shows a target image 502 and a single archived image 504 to which the target image is to be compared.

FIG. 5 assumes that procedures described above, with reference to FIG. 4, have already been performed to produce component descriptors for each image. Component descriptors for archived images can be created ahead of time and archived with the images or instead of the images.

An action 506 comprises determining the poses of the two images. For purposes of this analysis, a facial image is considered to have one of three poses: front (F), left (L), or right (R). To handle this pose category, three images are selected from an image training set, one image for each pose, and the other factors in these three images, such as person identity, illumination, expression remain the same. After measuring the similarity between these three gallery images and the probe face, the pose label of the most alike gallery image is assigned to the probe face.

An action 508 comprises determining component weighting for purposes of component descriptor comparison. There are multiple combinations of poses that might be involved in a pair of images: FF, LL, RR, LR (RL), LF (FL), and RF (FR). Depending on the pose combination, different components of the facial images can be expected to yield more valid results when compared to each other. Accordingly, weights or weighting factors are formulated for each pose combination and used when evaluating similarities between the images. More specifically, for each pose combination, a weighting factor is formulated for each facial component, indicating the relative importance of that component for purposes of comparison. Appropriate weighting factors for different poses can be determined by analyzing a set of training images, whose poses are known, using an SVM classifier.

An action 510 comprises comparing the weighted component descriptors of the two images and calculating a similarity score based on the comparison.

### An Exemplary Computer Environment

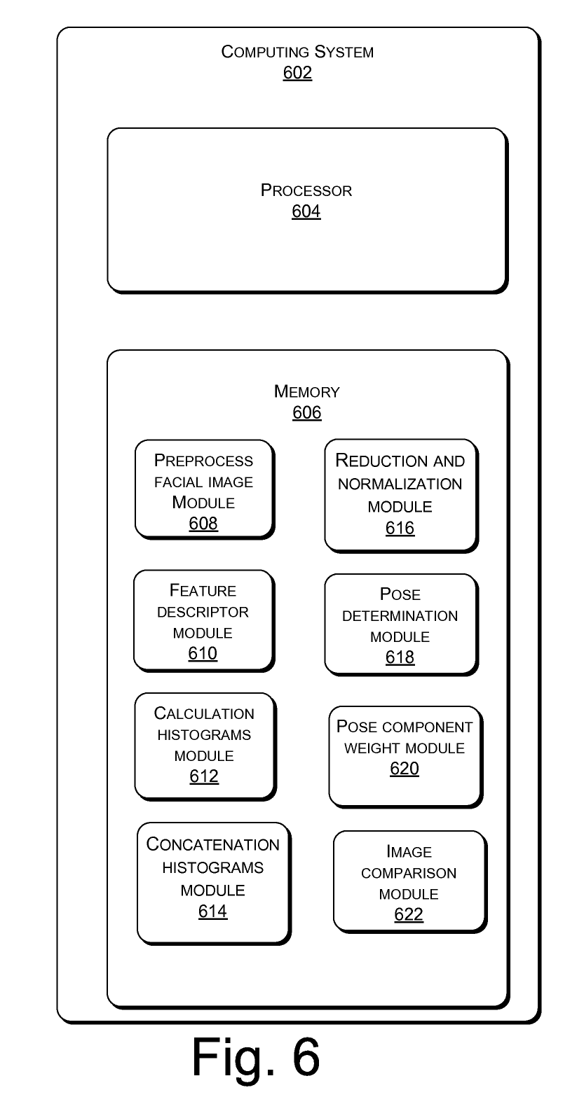

FIG. 6 illustrates an exemplary computing system 602, which can be used to implement the techniques described herein, and which may be representative, in whole or in part, of elements described herein. Computing system 602 may, but need not, be used to implement the techniques described herein. Computing system 602 is only one example and is not intended to suggest any limitation as to the scope of use or functionality of the computer and network architectures.

The components of computing system 602 include one or more processors 604, and memory 606.

Generally, memory 606 contains computer-readable instructions that are accessible and executable by processor 604. Memory 606 may comprise a variety of computer readable storage media. Such media can be any available media including both volatile and non-volatile storage media, removable and non-removable media, local media, remote media, optical memory, magnetic memory, electronic memory, etc.

Any number of program modules or applications can be stored in the memory, including by way of example, an operating system, one or more applications, other program modules, and program data, such as a preprocess facial image module 608, a feature descriptor module 610, a calculation histograms module 612, a concatenation histograms module 614, a reduction and normalization module 616, a pose determination module 618, a pose component weight module 620, and an image comparison module 622.

For example, preprocess facial image module 608 is configured to preprocessing the facial image to reduce or remove low-frequency and high-frequency illumination variations. Feature descriptor module 610 is configured to obtain feature vectors or descriptors corresponding respectively to pixels of the facial image. Calculation histograms module 612 is configured to calculate histograms of the feature descriptors. Concatenation histograms module 614 is configured to concatenate histograms of the patches, resulting in a single face descriptor corresponding to the facial image. Reduction and normalization module 616 is configured to reduce dimensionality of a face descriptor using one or more statistical vector quantization techniques and to normalize the reduced-dimensionality face descriptor to obtain a compressed and normalized face descriptor to obtain compressed & normalized face descriptor. Pose determination module 618 is configured to determine the poses of images. Pose component weight module 620 is configured to determine component weighting for purposes of component descriptor comparison. Image comparison module 622 is configured to compare the weighted component descriptors of the two images and calculating a similarity score based on the comparison.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A method of descriptor-based facial recognition, comprising:
obtaining feature descriptors corresponding respectively to pixels of the facial image;
calculating histograms of the feature descriptors, each histogram indicating the number of occurrences of each feature descriptor within a corresponding patch of the facial image;
concatenating the histograms to form a face descriptor;
reducing dimensionality of the face descriptor using one or more statistical vector quantization techniques; and
normalizing the reduced-dimensionality face descriptor.

2. A method as recited in claim 1, wherein obtaining a particular feature descriptor corresponding to a particular pixel comprises:
obtaining multiple feature vectors using different sampling patterns of neighboring pixels;
combining the multiple feature vectors to create the particular feature descriptor.

3. A method as recited in claim 1, further comprising quantizing the feature descriptors using a machine-learned encoding before calculating the histograms.

4. A method as recited in claim 1, wherein the one or more statistical vector quantization techniques comprise feature extraction.

5. A method as recited in claim 1, wherein the one or more statistical vector quantization techniques comprise principle component analysis.

6. A method as recited in claim 1, wherein the one or more statistical vector quantization techniques comprise reducing the dimensionality of the face descriptor to a dimension of 400.

7. A method as recited in claim 1, wherein the normalizing comprises L₁ or L₂ normalization.

8. A method of creating an encoder for use in descriptor-based facial recognition, comprising:
for a plurality of sample facial images, obtaining feature descriptors corresponding respectively to pixels of the facial images;
creating a mapping of the feature descriptors to quantized codes based on statistical dimensionality reduction.

9. A method as recited in claim 8, wherein the statistical dimensionality reduction comprises principal component analysis.

10. A method as recited in claim 8, wherein the statistical dimensionality reduction comprises K-means clustering.

11. A method as recited in claim 8, wherein the statistical dimensionality reduction comprises random-projection tree analysis.

12. A method as recited in claim 8, wherein obtaining a particular feature descriptor corresponding to a particular pixel comprises:
obtaining multiple feature vectors using different sampling patterns of neighboring pixels; and
combining the multiple feature vectors to create the particular feature descriptor.

13. A method of descriptor-based facial recognition, comprising:
extracting component images from a facial image, each component image corresponding to a facial component;
obtaining feature descriptors corresponding respectively to pixels of the component images; and
for each component image, calculating one or more histograms of the feature descriptors within the component image to form a component descriptor corresponding to each of the component images.

14. A method as recited in claim 13, further comprising:
reducing dimensionality of the component descriptors using principal component analysis; and
normalizing the reduced-dimensionality component descriptors.

15. A method as recited in claim 13, further comprising:
quantizing the feature descriptors using a machine-learned encoding before calculating the component descriptors.

16. A method as recited in claim 13, wherein obtaining the feature descriptor corresponding to a particular pixel comprises sampling neighboring pixels.

17. A method as recited in claim 13, wherein obtaining a particular feature descriptor corresponding to a particular pixel comprises:
obtaining multiple feature vectors using different sampling patterns of neighboring pixels; and
combining the multiple feature vectors to create the particular feature descriptor.

18. A method as recited in claim 13, further comprising:
comparing corresponding component descriptors of different facial images to determine similarity between the different facial images.

19. A method as recited in claim 13, further comprising:
comparing corresponding component descriptors of different facial images to determine similarity between the different facial images; and
during the comparing, assigning different weights to different component descriptors depending on the facial poses represented by the different facial images.

20. A method as recited in claim 13, further comprising:
quantizing the feature descriptors using a machine-learned encoding before calculating the component descriptors
reducing dimensionality of the component descriptors using principal component analysis; and
normalizing the reduced-dimensionality component descriptors
determining facial poses of different facial images;
comparing corresponding component descriptors of the different facial images to determine similarity between the different facial images; and
during the comparing, assigning different weights to different component descriptors depending on the facial poses represented by the different facial images.
